(19) United States
(12) Patent Application Publication
(10) Pub. No.: US 2016/0162811 A1
(43) Pub. Date: Jun. 9, 2016

(54) METHOD AND SYSTEM FOR FACILITATING REMOTE CHECK-IN INTO HOTELS

(71) Applicant: ThinkSmart LLC, Novi, MI (US)

(72) Inventors: Nilesh Madanlal BHATTAD, Maharashtra (IN); Sagar Shankar PATIL, Maharashtra (IN)

(21) Appl. No.: 14/955,634

(22) Filed: Dec. 1, 2015

(30) Foreign Application Priority Data
Dec. 3, 2014 (IN) 3878/MUM/2014

(51) Int. Cl. G06Q 10/02; G06Q 50/12

(52) U.S. Cl. CPC G06Q 10/02; G06Q 50/12

(57) ABSTRACT

Disclosed is a system for facilitating remote check-in to a user in a room, of a hotel, booked by the user. A booking detail receiving module receives booking details pertaining to a room, of a hotel, from a user. The booking details may comprise reservation details, hotel details, and personal details. A validation module validates the booking details against previously stored booking details. A unique reservation code module generates a unique reservation code when the room is available for the specific period of time. The unique reservation code module further transmits the unique reservation code to the user. A verification module verifies the unique reservation code and the booking details. An acknowledgment transmission module transmits an acknowledgment to the user upon verifying the unique reservation code and the booking details. In one aspect, the acknowledgment indicates details of the room that has been allotted to the user.

### PRIORITY INFORMATION

The present application claims priority to Indian Provisional Patent Application No. 3878/MUM/2014, filed on Dec. 3, 2014, the entirety of which is hereby incorporated by reference.

### TECHNICAL FIELD

The present disclosure described herein, in general, relates to a method and system for facilitating remote check-in into hotels.

### BACKGROUND

It has been observed that check in at hotels has always been a nuisance for tourists. This is because, after travelling a long journey, the tourists have to invest sometime at the reception of the hotel in order to fulfill the check-in formalities. Further, procedures for the check-in may vary depending on location of the hotel and the category of hotel selected by the tourists. For example, the hotel located near airports or railway stations are busiest than the hotels located at tourist places like hill station. Therefore, the people directly coming from distant locations will generally opt to stay at the hotels near the airports or the railway stations so as to avoid further traveling. After reaching at hotel, nearest to the airports or the railway stations, the tourists may further have to wait in the long queues at the reception for fulfilling the check-in formalities which becomes the nuisance for tourists.

In order to fulfill the check-in formalities, the tourists have to present identity proof in order to verify their identity. Examples of the identity proof, may include, but not limited to, a driving license, a passport, a ration card, a permanent account number (PAN) cart, and a voter-id card. Since, some people do not carry at least one of the at least one identity proof each time they travel, it again becomes a challenge for the tourists while fulfilling the check-in formalities. Thus, in view of the above, there is need of a system and method which will overcome the limitations observed in the existing methods of check-in the hotel.

### SUMMARY

Before the present apparatuses and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to a method and system for facilitating remote check-in to a user in a room, of a hotel, booked by the user and the concepts are further described below in the detailed description. This summary is not intended to identify essential features of the disclosure nor is it intended for use in determining or limiting the scope of the disclosure.

In one implementation, a system for facilitating remote check-in to a user in a room, of a hotel, booked by the user is disclosed. In one aspect, the system may comprise a processor and a memory coupled to the processor. The processor may execute a plurality of modules stored in the memory. The plurality of modules may comprise a booking detail receiving module, a validation module, a unique reservation code module, a verification module, and an acknowledgment transmission module. The booking detail receiving module may receive booking details pertaining to a room, of a hotel, from a user. The booking details may comprise reservation details, hotel details, and personal details. The validation module may validate the booking details against previously stored booking details. The booking details may be validated to check availability of the room for a specific period of time specified in the booking details. The unique reservation code module may generate a unique reservation code when the room is available for the specific period of time. The unique reservation code module may further transmit the unique reservation code to the user. The verification module may verify the unique reservation code and the booking details. In one aspect, the unique reservation code may be verified, upon receiving the unique reservation code from the user, in order to confirm the booking of the room. The receipt of the unique reservation code indicates that the user has requested for remote check-in into the room. The acknowledgment transmission module may transmit an acknowledgment to the user upon verifying the unique reservation code and the booking details. In one aspect, the acknowledgment indicates details of the room that has been allotted to the user thereby facilitating the remote check-in to the user in the room of the hotel.

In yet another implementation, a method for facilitating remote check-in to a user in a room, of a hotel, booked by the user is disclosed. In order to facilitate the remote check-in to the user, initially, booking details pertaining to the room of the hotel may be received. The booking details may comprise reservation details, hotel details, and personal details. Upon receiving the booking details, the booking details may be validated against previously stored booking details. The booking details may be validated to check availability of the room for a specific period of time specified in the booking details. Subsequent to the validation of the booking details, a unique reservation code may be generated when the room is available for the specific period of time. Subsequently, the unique reservation code may be transmitted to the user. Based upon the unique reservation code received from the user, the unique reservation code and the booking details may be verified. In one aspect, the unique reservation code may be verified in order to confirm the booking of the room. The receipt of the unique reservation code indicates that the user has requested for remote check-in into the room. Subsequent to the verification of the unique reservation code and the booking details, an acknowledgment may be transmitted to the user. The acknowledgment indicates details of the room that has been allotted to the user thereby facilitating the remote check-in to the user in the room of the hotel. In one aspect, the aforementioned method for facilitating remote check-in to the user in the room, of the hotel, booked by the user is performed by a processor using programmed instructions stored in a memory.

In yet another implementation, non-transitory computer readable medium embodying a program executable in a computing device for facilitating remote check-in to a user in a room, of a hotel, booked by the user is disclosed. The program may comprise a program code for receiving booking details pertaining to a room, of a hotel, from a user, wherein the booking details comprise reservation details, hotel details, and personal details. The program may further comprise a program code for validating the booking details against previously stored booking details, wherein the booking details are validated to check availability of the room for a specific period of time specified in the booking details. The program may further comprise a program code for generating a unique reservation code when the room is available for the specific period of time. The program may further comprise a program code for transmitting the unique reservation code to the user. The program may further comprise a program code for verifying the unique reservation code and the booking details, wherein the unique reservation code is verified, upon receiving the unique reservation code from the user, in order to confirm the booking of the room, and wherein the receipt of the unique reservation code indicates that the user has requested for remote check-in into the room. The program may further comprise a program code for transmitting an acknowledgment to the user upon verifying the unique reservation code and the booking details, wherein the acknowledgment indicates details of the room that has been allotted to the user thereby facilitating the remote check-in to the user in the room of the hotel.

### BRIEF DESCRIPTION OF THE DRAWINGS

The foregoing detailed description of embodiments is better understood when read in conjunction with the appended drawing. For the purpose of illustrating the disclosure, there is shown in the present document example constructions of the disclosure; however, the disclosure is not limited to the specific methods and apparatus disclosed in the document and the drawings.

The detailed description is described with reference to the accompanying figure. In the figure, the left-most digit(s) of a reference number identifies the figure in which the reference number first appears. The same numbers are used throughout the drawings to refer like features and components.

FIG. 1 illustrates a block diagram of a system for facilitating remote check-in to a user in a room, of a hotel, booked by the user is shown, in accordance with an embodiment of the present disclosure.

FIG. 2 illustrates the system 102, in accordance with an embodiment of the present disclosure.

FIG. 3 illustrates an embodiment, in accordance with an embodiment of the present disclosure.

FIG. 4 illustrates a method for facilitating remote check-in to the user in the room, of the hotel, booked by the user, in accordance with an embodiment of the present disclosure.

The figure depicts an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that, the singular forms “a,” “an,” and “the” include plural references unless the context clearly dictates otherwise. Although any apparatuses and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The present system and method facilitates remote check-in to a user in a room, of a hotel, booked by the user is disclosed. The system facilitates remote check-in to a tourist (hereinafter referred to as a user) in a hotel booked by the user. In order to book one or more rooms in the hotel, the user provides booking details to a hotel server of the hotel. The booking details may include, but not limited to, reservation details, hotel details, and personal details. Upon receiving, the hotel server validates the booking details against previously stored booking details. In one aspect, the booking details may be validated to check availability in the hotel for the specific period of time specified in the booking details. Once the booking in the hotel for the user is confirmed, the hotel server may generate a unique reservation code and transmits the unique reservation code to the user.

In one aspect, the unique reservation code may be received by the user from the hotel server. In order to remote check-in, initially, the user has to install a mobile application on a smart phone carried by the user. In one aspect, the mobile application may be communicatively coupled with a plurality of hotel servers, including the hotel server. In another aspect, the mobile application may be communicatively coupled with the hotel server via a centralized server. After installing the mobile application, the user transmits the unique reservation code, via the centralized server, to the hotel server when the mobile application is communicatively coupled with the hotel server via the centralized server. The receipt of the unique reservation code indicates that the user has requested for remote check-in into the room. The unique reservation code is then verified by the hotel server; wherein the hotel server verifies the unique reservation code in order confirm the booking of the one or more rooms in the hotel booked by the user.

Once the unique reservation code is verified, an acknowledgement may be transmitted on the smart phone belongs to the user. In one aspect, the acknowledgement may be transmitted via the centralized server when the mobile application is communicatively coupled with the hotel server via the centralized server. In one aspect, the acknowledgment indicates details of the one or more rooms, of the hotel, that has been allotted to the user thereby facilitating the remote check-in to the user in the room of the hotel.

While aspects of described system and method for facilitating remote check-in to the user in the room, of the hotel, booked by the user may be implemented in any number of different computing systems, environments, and/or configurations, the embodiments are described in the context of the following exemplary system.

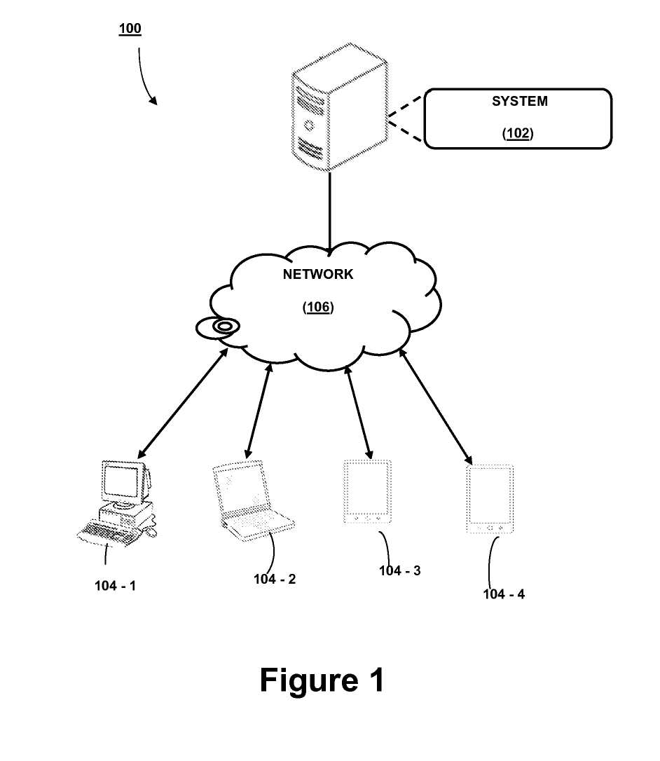

Referring now to FIG. 1, a network implementation 100 of a system 102 for facilitating remote check-in to a user in a room, of a hotel, booked by the user is disclosed. The system 102 receives booking details pertaining to a room, of a hotel, from a user. The booking details may comprise reservation details, hotel details, and personal details. The system 102 then validates the booking details against previously stored booking details. The booking details may be validated to check availability of the room for a specific period of time specified in the booking details. The system 102 then generates a unique reservation code when the room is available for the specific period of time. The system 102 then transmits the unique reservation code to the user. The system 102 then verifies the unique reservation code and the booking details. In one aspect, the unique reservation code may be verified, upon receiving the unique reservation code from the user, in order to confirm the booking of the room. The receipt of the unique reservation code indicates that the user has requested for remote check-in into the room. The system 102 then transmits an acknowledgment to the user upon verifying the unique reservation code and the booking details. In one aspect, the acknowledgment indicates details of the room that has been allotted to the user thereby facilitating the remote check-in to the user in the room of the hotel

Although the present disclosure is explained considering that the system 102 is implemented on a server, it may be understood that the system 102 may also be implemented in a variety of computing systems, such as a laptop computer, a desktop computer, a notebook, a workstation, a mainframe computer, a server, a network server, a cloud-based computing environment and the like. It will be understood that the system 102 may be accessed by multiple users through one or more user devices 104-1, 104-2, 104-3, 104-N, collectively referred to as user 104 hereinafter, or applications residing on the user devices 104 or a smart phone 104. In one implementation, the system 102 may comprise the cloud-based computing environment in which a user, interchangeably may referred to as a consumer, may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

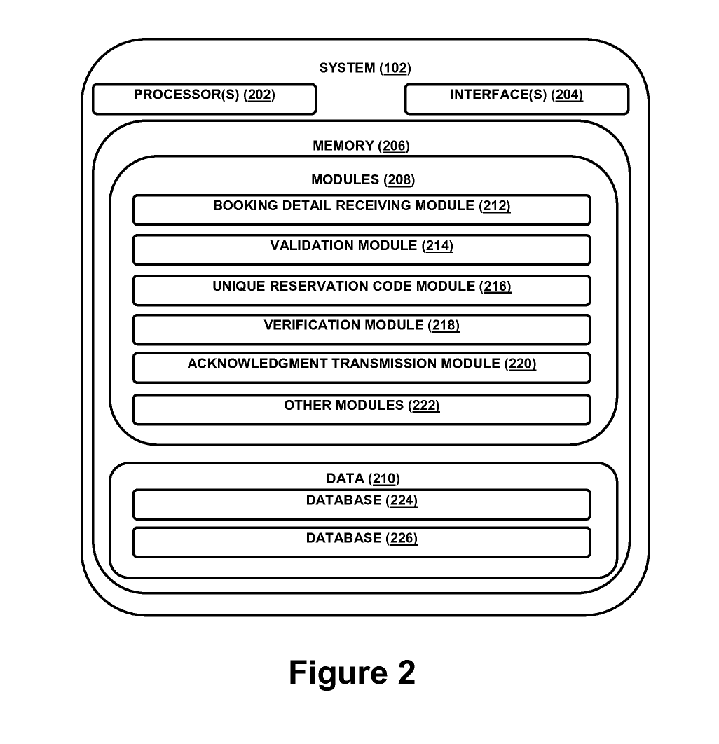

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium and computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a booking detail receiving module 212, a validation module 214, a unique reservation code module 216, a verification module 218, an acknowledgment transmission module 220, and other module 222. The other modules 222 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may include data generated as a result of the execution of one or more modules in the modules 208. Further, the data 210 may include a database 224 and other data 226. The other data 226 may include data generated as a result of the execution of one or more modules in the other modules 224. The detailed description of the modules 208 along with other components of the system 102 is further explained by referring to FIG. 2.

Further referring to FIG. 2. In one implementation, at first, a user may use the user device 104 to access the system 102 via the I/O interface 204. The user may register themselves using the I/O interface 204 in order to use the system 102. The system 102 facilitates remote check-in to a tourist (hereinafter referred to as a user 104) in a hotel booked by the user 104. In one aspect, the user 104 may accesses the I/O interface 204 of the system 102 for facilitating remote check-in to a user 104 in a room, of a hotel, booked by the user 104. In order to facilitate remote check-in to the user 104 in the room, the system 102 may employ the plurality of modules i.e. the booking detail receiving module 212, the validation module 214, the unique reservation code module 216, the verification module 218, and the acknowledgment transmission module 220. The detailed working of the plurality of modules is described below.

In order to book the rooms in the hotel, the booking detail receiving module 212 receives booking details pertaining to the room, of the hotel, from the user 104. The booking details may include, but not limited to, reservation details, hotel details, and personal details. The reservation details may include, but not limited to, start date, end date, check in time, check out time, check in instructions, room number and room type. In one example, the check in instructions indicates various requirements specified by the user 104 such Meal type (Veg/Non-Veg), Breakfast details etc. The hotel details may include, but not limited to, hotel name, address, phone number, email, and fax number. The personal details may include, but not limited to, name, address, id proof type, id proof image, phone number, and email ID. In one embodiment, the personal details may be stored in the database 224 for future reference. In one embodiment, the id proof may be scanned by using an image capturing device, integrated with a smart phone, in order to store in the in the database 224 in the form of an image. In one aspect, the smart phone 104 may be associated to the user 104.

Upon receiving the booking details, the validation module 214 validates the booking details against previously stored booking details in the database 224. In one aspect, the booking details may be validated to check availability in the hotel for the specific period of time specified in the booking details. Once the booking in the hotel for the user 104 is confirmed, the unique reservation code module 216 generates a unique reservation code. The unique reservation code module 216 further transmits the unique reservation code to the user 104.

In order to facilitate remote check-in to the user 104, initially, the user 104 has to install a mobile application on a smart phone carried by the user 104. In one embodiment, the mobile application may further facilitate to remote check-out to the user 104. In one embodiment, the mobile application is communicatively coupled with the system 102 via the network 106. In one aspect, the personal details corresponding to the user 104 may be synchronized with the database 224. The synchronization facilitates to upload the personal details on the database 224 thereby avoiding the user 104 to carry identification proof with them.

Subsequent to the installation of the mobile application, the verification module 218 enables the user 104 to transmit the unique reservation code to the system 102. The verification module 218 may then verify the unique reservation code and the booking details. The unique reservation code may be verified, upon receiving the unique reservation code from the user 104, in order to confirm the booking of the room. In one aspect, the receipt of the unique reservation code indicates that the user 104 has requested for remote check-in into the room. In one embodiment, the verification module 218 verifies the booking details by referring the identification proof type and the identification proof image uploaded by the user 104 in the database 224.

The unique reservation code and the booking details are then verified by the system 102 in order to confirm the booking of the room in the hotel booked by the user 104. Once the unique reservation code and the booking details are verified, the acknowledgment transmission module 220 transmits the acknowledgement by transmitting a layout of a plurality of rooms, of the hotel, on a display unit of the smart phone associated to the user 104. The acknowledgment transmission module 220 may then enable the user 104 to select a room of the plurality of rooms of his/her choice. The acknowledgment transmission module 220 may then receive details of the room selected by the user 104 from the layout.

Upon receiving the details of the room, the acknowledgment transmission module 220 transmits an acknowledgment to the user 104. The acknowledgment indicates details of the room that has been allotted to the user 104 thereby facilitating the remote check-in to the user 104 in the room of the hotel. Thus, in this manner, the user 104 may be facilitated to remote check-in into the hotel without carrying the identification proof and waiting in long queues for fulfilling the check-in formalities at the reception of the hotel.

In one embodiment, the smart phone may further be used to lock or unlock the room of the hotel by using Near Field Communication (NFC) technique.

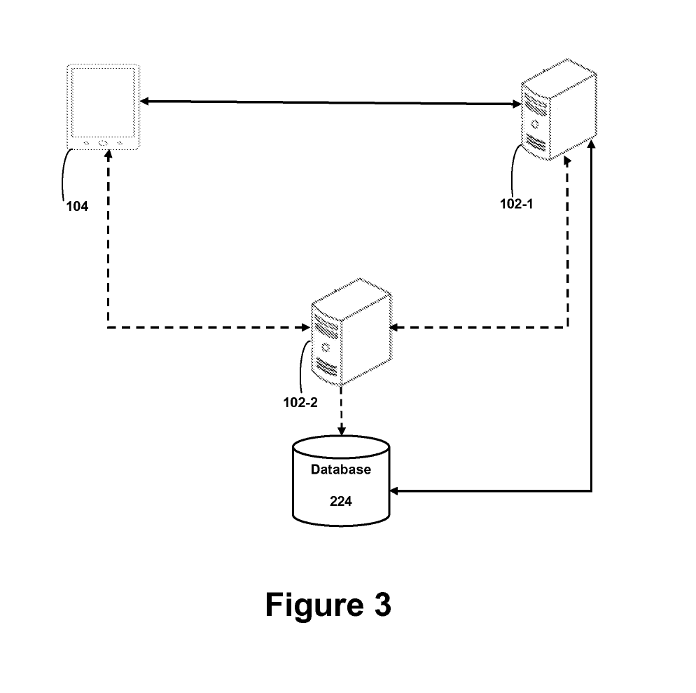

Now referring to FIG. 3. In order to facilitate remote check-in to the user 104 in the room, in one embodiment, the user 104 may communicate with a hotel server 102-1 directly for remotely check-in a room, of a hotel, booked by the user 104. It may be understood that the system 102 may be employed in the hotel server 102-1 when the user 104 directly communicates with the hotel server 102-1. In another embodiment, the user 104 may communicate with the hotel server 102-1 via a centralized server 102-2. It may be understood that the system 102 may be employed in the centralized server 102-2 when the user 104 communicates with the hotel server 102-1 as illustrated in the FIG. 3.

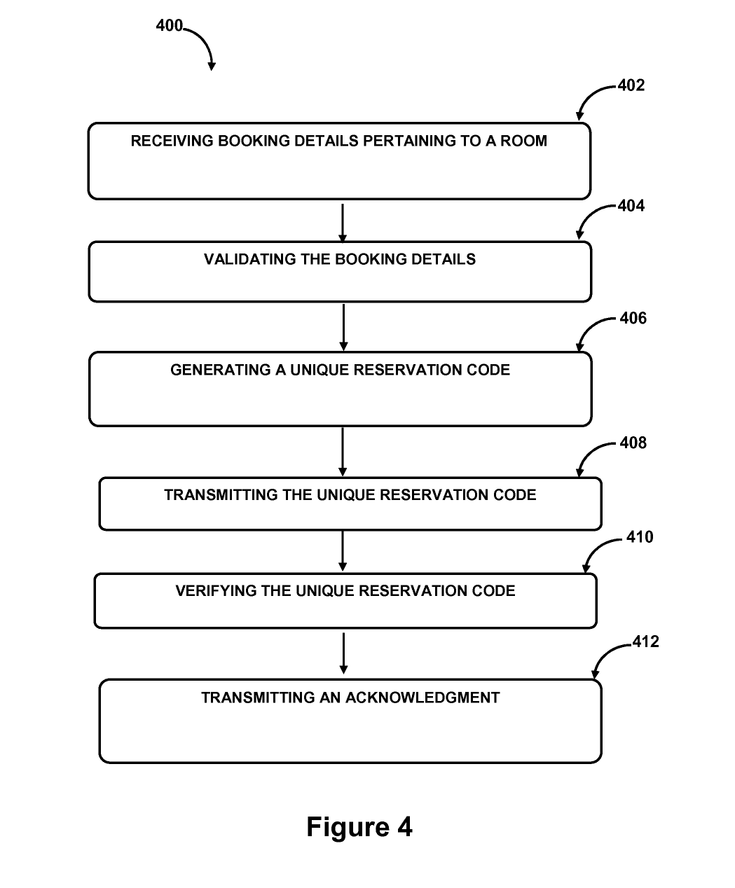

Referring now to FIG. 4, a method 400 for facilitating remote check-in to a user in a room, of a hotel, booked by the user is shown, in accordance with an embodiment of the present disclosure. The method 400 may be described in the general context of computer executable instructions. Generally, computer executable instructions can include routines, programs, objects, components, data structures, procedures, modules, functions, etc., that perform particular functions or implement particular abstract data types. The method 400 may be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the disclosure described herein. Furthermore, the method can be implemented in any suitable hardware, software, firmware, or combination thereof. However, for ease of explanation, in the embodiments described below, the method 400 may be considered to be implemented in the above described in the system 102.

At block 402, booking details pertaining to a room, of a hotel, from a user may be received. In one aspect, the booking details may comprise reservation details, hotel details, and personal details. In one implementation, the booking details may be received by the booking detail receiving module 212.

At block 404, the booking details may be validated against previously stored booking details. The booking details may be validated to check availability of the room for a specific period of time specified in the booking details. In one implementation, the booking details may be validated by the validation module 214.

At block 406, a unique reservation code may be generated when the room is available for the specific period of time. In one implementation, unique reservation code may be generated by the unique reservation code module 216.

At block 408, the unique reservation code may be transmitted to the user. In one implementation, the unique reservation code may be transmitted by unique reservation code module 216.

At block 410, the unique reservation code and the booking details may be verified. The unique reservation code may be verified, upon receiving the unique reservation code from the user, in order to confirm the booking of the room. The receipt of the unique reservation code indicates that the user has requested for remote check-in into the room. In one implementation, the unique reservation code and the booking details may be verified by the verification module 218.

At block 412, an acknowledgment may be transmitted to the user upon verifying the unique reservation code and the booking details. The acknowledgment indicates details of the room that has been allotted to the user thereby facilitating the remote check-in to the user in the room of the hotel. In one implementation, the acknowledgment may be transmitted by the acknowledgment transmission module 220.

Exemplary embodiments discussed above may provide certain advantages. Though not required to practice aspects of the disclosure, these advantages may include those provided by the following features.

Some embodiments enable a system and a method to save lot of waiting time for the customers at the reception of the hotel.

Some embodiments enable a system and a method to save cost on the staff of the hotels.

Some embodiments enable a system and a method to check in and check out from the hotel while on the go.

Some embodiments enable a system and a method to avoid carrying the identity proof since the personal details are uploaded on the centralized server.

Although implementations for methods and systems for facilitating remote check-in to a user in a room, of a hotel, booked by the user have been described in language specific to structural features and/or methods, it is to be understood that the appended claims are not necessarily limited to the specific features or methods described. Rather, the specific features and methods are disclosed as examples of implementations for facilitating remote check-in to the user in the room, of the hotel, booked by the user.

What is claimed is:

1. A method for facilitating remote check-in to a user in a room of a hotel, booked by the user, the method comprising:
receiving, by a processor, booking details pertaining to a room of a hotel from a user, wherein the booking details comprise reservation details, hotel details, and personal details;
validating, by the processor, the booking details against previously stored booking details, wherein the booking details are validated to check availability of the room for a specific period of time specified in the booking details;
generating, by the processor, a unique reservation code when the room is available for the specific period of time;
transmitting, by the processor, the unique reservation code to the user;
verifying, by the processor, the unique reservation code and the booking details, wherein the unique reservation code is verified, upon receiving the unique reservation code from the user, in order to confirm the booking of the room, and wherein the receipt of the unique reservation code indicates that the user has requested for remote check-in into the room; and
transmitting, by the processor, an acknowledgment to the user upon verifying the unique reservation code and the booking details, wherein the acknowledgment indicates details of the room that has been allotted to the user thereby facilitating the remote check-in to the user in the room of the hotel.

2. The method of claim 1, wherein the reservation details comprise start date, end date, check in time, check out time, check in instructions, room number and room type.

3. The method of claim 1, wherein the hotel details comprise hotel name, address, phone number, email, and fax number.

4. The method of claim 1, wherein the personal details comprise name, address, identification proof type, identification proof image, phone number, and email ID.

5. The method of claim 1, wherein the booking details are verified by checking the identification proof type and the identification proof image of the user.

6. The method of claim 1, wherein the acknowledgement is transmitted by
transmitting a layout of a plurality of rooms, of the hotel, on a display unit of a communication device associated to the user,
enabling the user to select the room of the plurality of rooms, and
receiving details of the room, of the plurality of rooms, selected by the user from the layout.

7. A system for facilitating remote check-in to a user in a room of a hotel, booked by the user, the system comprising:
a processor; and
a memory coupled to the processor, wherein the processor is capable of executing a plurality of modules stored in the memory, and wherein the plurality of modules comprising:
a booking detail receiving module for receiving booking details pertaining to a room of a hotel from a user, wherein the booking details comprise reservation details, hotel details, and personal details;
a validation module for validating the booking details against previously stored booking details, wherein the booking details are validated to check availability of the room for a specific period of time specified in the booking details;
a unique reservation code module for
generating a unique reservation code when the room is available for the specific period of time, and
transmitting the unique reservation code to the user;
a verification module for verifying the unique reservation code and the booking details, wherein the unique reservation code is verified, upon receiving the unique reservation code from the user, in order to confirm the booking of the room, and wherein the receipt of the unique reservation code indicates that the user has requested for remote check-in into the room; and
an acknowledgment transmission module for transmitting an acknowledgment to the user upon verifying the unique reservation code and the booking details, wherein the acknowledgment indicates details of the room that has been allotted to the user thereby facilitating the remote check-in to the user in the room of the hotel.

8. The system of claim 7, wherein the reservation details comprise start date, end date, check in time, check out time, check in instructions, room number and room type.

9. The system of claim 7, wherein the hotel details comprise hotel name, address, phone number, email, and fax number.

10. The system of claim 7, wherein the personal details comprise name, address, identification proof type, identification proof image, phone number, and email ID.

11. The system of claim 7, wherein the verification module verifies the booking details by checking the identification proof type and the identification proof image of the user.

12. The system of claim 7, wherein the acknowledgment transmission module transmits the acknowledgement by
transmitting a layout of a plurality of rooms, of the hotel, on a display unit of a communication device associated to the user,
enabling the user to select the room of the plurality of rooms, and
receiving details of the room, of the plurality of rooms, selected by the user from the layout.

13. A non-transitory computer readable medium embodying a program executable in a computing device for facilitating remote check-in to a user in a room, of a hotel, booked by the user, the program comprising:
a program code for receiving booking details pertaining to a room of a hotel from a user, wherein the booking details comprise reservation details, hotel details, and personal details;
a program code for validating the booking details against previously stored booking details, wherein the booking details are validated to check availability of the room for a specific period of time specified in the booking details;
a program code for generating a unique reservation code when the room is available for the specific period of time;
a program code for transmitting the unique reservation code to the user;
a program code for verifying the unique reservation code and the booking details, wherein the unique reservation code is verified, upon receiving the unique reservation code from the user, in order to confirm the booking of the room, and wherein the receipt of the unique reservation code indicates that the user has requested for remote check-in into the room; and
a program code for transmitting an acknowledgment to the user upon verifying the unique reservation code and the booking details, wherein the acknowledgment indicates details of the room that has been allotted to the user thereby facilitating the remote check-in to the user in the room of the hotel.

14. The non-transitory computer readable medium of claim 13, wherein the reservation details comprise start date, end date, check in time, check out time, check in instructions, room number and room type.

15. The non-transitory computer readable medium of claim 13, wherein the hotel details comprise hotel name, address, phone number, email, and fax number.

16. The non-transitory computer readable medium of claim 13, wherein the personal details comprise name, address, identification proof type, identification proof image, phone number, and email ID.

17. The non-transitory computer readable medium of claim 13, wherein the booking details are verified by checking the identification proof type and the identification proof image of the user.

18. The non-transitory computer readable medium of claim 13, wherein the program code for transmitting the acknowledgement comprises:
a program code for transmitting a layout of a plurality of rooms, of the hotel, on a display unit of a communication device associated to the user,
a program code for enabling the user to select the room of the plurality of rooms, and
a program code for receiving details of the room, of the plurality of rooms, selected by the user from the layout.
